(19) United States
(12) Patent Application Publication
(10) Pub. No.: US 2024/0046036 A1
(43) Pub. Date: Feb. 8, 2024

(54) PRE-PROCESSING FOR NATURAL LANGUAGE PROCESSING

(71) Applicant: BRITISH TELECOMMUNICATIONS PUBLIC LIMITED COMPANY, London (GB)

(72) Inventors: Aygul GARIFULLINA, London (GB); Mathias KERN, London (GB); Leonhard APPLIS, London (GB)

(21) Appl. No.: 18/258,867

(22) PCT Filed: Dec. 7, 2021
(86) PCT No.: PCT/EP2021/084649

§ 371 Date: Jun. 22, 2023

(30) Foreign Application Priority Data
Dec. 24, 2020 (GB) 2020629.8

(51) Int. Cl. G06F 40/284

(52) U.S. Cl. CPC G06F 40/284

(57) ABSTRACT

A computer implemented method of pre-processing an input text for a natural language processing operation based on a training corpus of documents, can include accessing a set of stop words including predetermined words for de-emphasis in the text for the natural language processing operation, the set of stop words being separated into at least two subsets including a first subset and a second subset, the second subset containing stop words predetermined to be of potential semantic significance to documents in the training corpus; tokenizing documents in a training corpus to an ordered set of corpus tokens; removing, from the set of corpus tokens, tokens corresponding to stop words in the first subset of stop words; generating a set of n-grams by identifying n-grams from groups of tokens in the set of corpus tokens based on predetermined rules for n-gram identification; tokenizing the input text to an ordered set of input text tokens; identifying groups of tokens in the set of input text tokens corresponding to n-grams in the set of n-grams and replacing, in the set of input text tokens, each identified group of tokens by a singular n-gram token; removing, from the set of input text tokens, tokens corresponding to stop words in the second subset of stop words; and processing the input text by the natural language processing operation based on the set of input text tokens for the input text.

### PRIORITY CLAIM

The present application is a National Phase entry of PCT Application No. PCT/EP2021/084649, filed Dec. 7, 2021, which claims priority from GB Patent Application No. 2020629.8, filed Dec. 24, 2020, each of which is hereby fully incorporated herein by reference.

### TECHNICAL FIELD

The present disclosure relates to pre-processing input text for processing by a natural language processing operation.

### BACKGROUND

Natural language processing (NLP) is a field of computer science concerned with the processing of natural human language by computer systems by automated processing of human language in speech or text form to derive meaning from it. NLP has many applications including spam detection for emails, translation between languages, grammar and spell check and correction, social media trends monitoring, sentiment analysis for customer reviews, voice driven interfaces for virtual assistants, handling medical notes, insurance claims, pre-filtering resumes for recruitment and others.

NLP operations depend on effective pre-processing of text so that the text is suitable for processing by an NLP application. Pre-processing conventionally includes:
Normalization of text such as by applying consistent lower-case to all text, replacing numerals with words, adapting infections, etc.;
Noise removal such as by removing predetermined words such as common words like “we”, “are” and “I”; and
Tokenization by resolving text to individual tokens such as tokens representing words in the text.

In particular, stop word removal is beneficial because the inclusion of common and frequently used words in text can constitute a type of noise in the text that impacts the effectiveness of NLP operations. Thus, it is beneficial to remove stop words from text. Such removal can be achieved on the basis of predefined lists of stop words such as those defined by the Natural Language Toolkit (NLTK) including words such as:
[‘i’, ‘me’, ‘my’, ‘myself’, ‘we’, ‘our’, ‘ours’, ‘ourselves’, ‘you’, “you're”, “you've”, “you'll”, “you'd”, ‘your’, ‘yours’, ‘yourself’, ‘yourselves’, ‘he’, ‘him’, ‘his’, ‘himself’, ‘she’, “she's”, ‘her’, ‘hers’, ‘herself’, ‘it’, “it's”, ‘its’, ‘itself’, ‘they’, ‘them’, ‘their’, ‘theirs’, ‘themselves’, ‘what’, ‘which’, ‘who’, ‘whom’ ‘this’, ‘that’, “that'll”, ‘these’, ‘those’, ‘am’, ‘is’, ‘are’, ‘was’, ‘were’, be′, ‘been’, ‘being’, ‘have’, ‘has’, ‘had’, ‘having’, ‘do’, ‘does’, ‘did’, ‘doing’, ‘a’, ‘an’, ‘the’, ‘and’, ‘but’, ‘if’, ‘of’, ‘because’, ‘as’, ‘until’, ‘while’, ‘of’, ‘at’, ‘by’, ‘for’, ‘with’, ‘about’, ‘against’, ‘between’, ‘into’, ‘through’, ‘during’, ‘before’, ‘after’, ‘above’, ‘below’, ‘to’, ‘from’, ‘up’, ‘down’, ‘in’, ‘out’, ‘on’, ‘off’, ‘over’, ‘under’, ‘again’, ‘further’, ‘then’, ‘once’, ‘here’, ‘there’, ‘when’, ‘where’, ‘why’, ‘bow’, ‘all’, ‘any’, both', ‘each’, ‘few’, ‘more’, ‘most’, ‘other’, ‘some’, ‘such’, ‘no’, ‘nor’, ‘not’, ‘only’, ‘own’, ‘same’, ‘so’, ‘than’, ‘too’, ‘very’, ‘s’, ‘t’, ‘can’, ‘will’, ‘just’, ‘don’, “don't”, ‘should’, “should've”, ‘now’, ‘d’, ‘ll’, ‘m’, ‘o’, ‘re’, ‘ye’, ‘y’, ‘ain’, ‘aren’, “aren't”, ‘couldn’, “couldn't”, ‘didn’, “didn't”, ‘doesn’, “doesn't”, ‘hadn’, “hadn't”, ‘hasn’, “hasn't”, ‘haven’, “haven't”, ‘isn’, “isn't”, ‘ma’, ‘mightn’, “mightn't”, ‘mustn’, “mustn't”, ‘needn’, “needn't”, ‘shan’, “shan't”, ‘shouldn’, “shouldn't”, ‘wasn’, “wasn't”, ‘weren’, “weren't”, ‘won’, “won't”, ‘wouldn’, “wouldn't”]

The internet publication “Why you should avoid removing STOPWORDS—Does removing stopwords really improve model performance?” (Gagandeep Singh, 24 Jun. 2019, available at www.medium.com) recognizes that stop word removal as part of pre-processing can result in a change to the meaning of a text which can be problematic in, for example, sentiment analysis. On the other hand, the publication also acknowledges that a failure to remove stop words lead to noise in an NLP dataset that can affect the effectiveness of NLP operations operating on the dataset.

### SUMMARY

It is therefore desirable to address the challenge of noise in pre-processing NLP datasets recognizing the benefit of retaining semantic meaning of a processed text.

According to a first aspect of the present disclosure, there is a provided a computer implemented method of pre-processing an input text for a natural language processing operation based on a training corpus of documents, the method comprising: accessing a set of stop words including predetermined words for de-emphasis in the text for the natural language processing operation, the set of stop words being separated into at least two subsets including a first subset and a second subset, the second subset containing stop words predetermined to be of potential semantic significance to documents in the training corpus; tokenizing documents in a training corpus to an ordered set of corpus tokens; removing, from the set of corpus tokens, tokens corresponding to stop words in the first subset of stop words; generating a set of n-grams by identifying n-grams from groups of tokens in the set of corpus tokens based on predetermined rules for n-gram identification; tokenizing the input text to an ordered set of input text tokens; identifying groups of tokens in the set of input text tokens corresponding to n-grams in the set of n-grams and replacing, in the set of input text tokens, each identified group of tokens by a singular n-gram token; removing, from the set of input text tokens, tokens corresponding to stop words in the second subset of stop words; and processing the input text by the natural language processing operation based on the set of input text tokens for the input text.

In some embodiments, tokenizing includes identifying words and generating a token for each identified word.

In some embodiments, identifying n-grams from groups of tokens in the set of corpus tokens further includes: applying part of speech tags to each token in the set of corpus tokens; generating a candidate n-gram for consecutive groups of n tokens in the set of corpus tokens; and removing candidate n-grams failing to satisfy the rules for n-gram identification.

In some embodiments, the rules for n-gram identification include rules defining acceptable sequences of part of speech tags.

In some embodiments, the method further comprises deduplicating the set of n-grams by consolidating n-grams containing identical sets of words irrespective of the order of the words.

In some embodiments, generating the set of n-grams further includes removing identified n-grams from the set of n-grams where a frequency of occurrence of each of the identified n-grams fails to meet a predetermined threshold frequency.

In some embodiments, each document in the training corpus and the input text are further pre-processed by normalization including one or more of: applying a consistent lower or uppercase to words; applying a stemmer function to words; and applying a lemmatization function to words.

According to a second aspect of the present disclosure, there is a provided a computer system including a processor and memory storing computer program code for performing the method set out above.

According to a third aspect of the present disclosure, there is a provided a computer system including a processor and memory storing computer program code for performing the method set out above.

### BRIEF DESCRIPTION OF THE DRAWINGS

Embodiments of the present disclosure will now be described, by way of example only, with reference to the accompanying drawings, in which:

FIG. 1 is a block diagram a computer system suitable for the operation of embodiments of the present disclosure.

FIG. 2 is a component diagram of an arrangement for pre-processing an input text for a natural language processing (NLP) operation in accordance with embodiments of the present disclosure.

FIG. 3 is a flowchart of a method of pre-processing an input text for a natural language processing operation in accordance with embodiments of the present disclosure.

### DETAILED DESCRIPTION

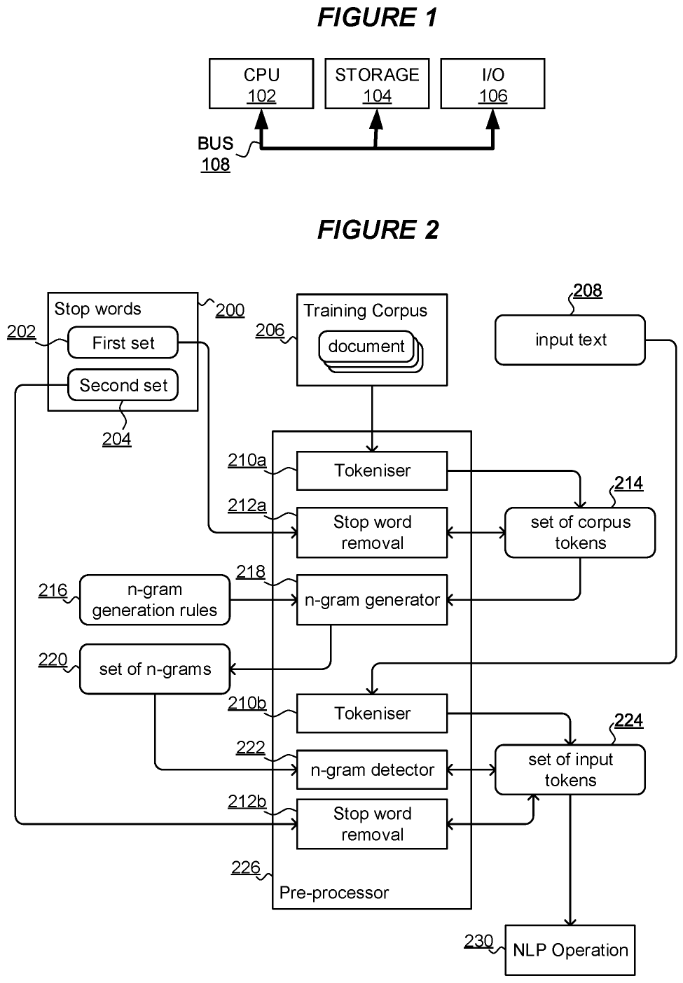

FIG. 1 is a block diagram of a computer system suitable for the operation of embodiments of the present disclosure. A central processor unit (CPU) 102 is communicatively connected to a storage 104 and an input/output (I/O) interface 106 via a data bus 108. The storage 104 can be any read/write storage device such as a random-access memory (RAM) or a non-volatile storage device. An example of a non-volatile storage device includes a disk or tape storage device. The I/O interface 106 is an interface to devices for the input or output of data, or for both input and output of data. Examples of I/O devices connectable to I/O interface 106 include a keyboard, a mouse, a display (such as a monitor) and a network connection.

FIG. 2 is a component diagram of an arrangement for pre-processing an input text 208 for a natural language processing (NLP) operation 230 in accordance with embodiments of the present disclosure. A pre-processor component 226 is provided as a hardware, software, firmware or combination component for performing pre-processing operations on an input text 208 for subsequent processing by an NLP operation 230. The NLP operation can be, for example, an NLP application for processing a tokenized version of the input text 208, such as to extract semantic meaning, take instructions from the text, as input to a software application, process, function or routine, or for other purposes as will be apparent to those skilled in the art. For example, the NLP operation 230 can be an operation of a virtual assistant or the like, and the input text 208 can be spoken or written word such as an utterance or the like as input to the operation 230.

The pre-processor component 226 operates with a training corpus 206 of documents selected as a basis for defining a set of n-grams 220 for use in pre-processing the input text 208. As will be apparent to those skilled in the art of NLP, n-grams are contiguous sequences of items in a sample of text (such as a record of speech). In embodiments of the present disclosure, n-grams are representations of groups of contiguous words generated on the basis of the documents in the training corpus 206 by an n-gram generator 218 using n-gram generation rules 216, as will be described below. While n-grams are used here, it will be appreciated by those skilled in the art that bigrams, trigrams or other n-grams may be employed alone or in combination.

To generate the n-grams 220, the pre-processor 226 receives or accesses the documents of the training corpus 206 for tokenization by a tokenizer component 210a as a hardware, software, firmware or combination component for generating an ordered set of corpus tokens 214 including tokens from documents in the corpus 206. Tokenization is a common task in NLP and will be familiar to those skilled in the art. In practice, tokenization involves separating text, such as the text in documents of the corpus 206, into smaller units. According to embodiments of the present disclosure those smaller units are individual words. Some embodiments of the present disclosure use a training corpus 206 of documents in which the documents are relevant to a domain, context, topic, theme or application of the input text 208, such as documents on a particular topic, genre, field or the like.

Subsequently, the pre-processor 226 performs stop word removal by a stop word removal component 212a. Whereas stop word removal is known in conventional NLP pre-processing, embodiments of the present disclosure adopt a novel approach in which a set of stop words 200 is separated into at least two subsets including a first set 202 and a second set 204. In some embodiments, the first and second sets 202, 204 are disjoint. Whereas the overall set of stop words 200 can constitute a conventional set of stop words, such as those defined by the Natural Language Toolkit (NLTK), additionally words in specific domain(s), context(s) or topic(s) or other indications of relevance can be included in the set of stop words 200. The second set 204 is characterized as containing stop words predetermined to be of potential semantic significance to documents in the training corpus 206. Thus, whereas stop words conventionally include common words that are selected for being removed or ignored in NLP pre-processing, embodiments of the present disclosure recognize the semantic significance of some subset of the set of stop words 200, the second set 204, such significance being, for example, words that affect the meaning of other words in a text. For example, the word “not” will change the meaning of other words such as in a statement “The product is not really very good”, where removal of the word “not” completely transforms the sentiment and meaning of the statement. Thus, the word “not” may be considered to have a semantic significance and is thus included in the second set 204. In contrast, the first set 202 of stop words is selected to include words having lesser or no semantic significance relative to the second set 204.

The stop word removal component 212a operates on the set of corpus tokens 214 generated by the tokenizer 210a to remove stop words in the first set 202 from the set of corpus tokens 214. Thus, at this stage, the set of corpus tokens 214 continues to include words in the second set 204. Subsequently, the n-gram generator component 218 is operable to generate the set of n-grams 220 on the basis of n-gram generation rules 216. The generation of n-grams includes the identification of groups of tokens in the set of corpus tokens 214 according to the n-gram rules 216. In some embodiments of the present disclosure, the n-gram generation rules 216 include rules defined in terms of “part of speech” (POS) tags applied to tokens in the set of corpus tokens 214. As will be apparent to those skilled in the art, POS tagging can be performed on tokens for a document or text by identifying, for each token and groups of tokens, a designation of a part of text for the token(s), such as a POS tag taken from a tagset. Example POS tags can identify Noun Phrases (NP), Verb Phrases (VP), Adjective Phrases (AdjP), Adverb Phrases (AdvP) and/or Preposition Phrases (PP). Examples of POS tagging techniques can be found in the paper “Tagging and Chunking with Bigrams” (Ferran Pla, Antonio Molina and Natividad Prieto, 2000). Thus, the n-gram generation rules can define acceptable POS tags to define acceptable phrases suitable for indication as an n-gram. Accordingly, the n-gram generator 218 can initially identify candidate n-grams for consecutive groups of n tokens in the set of corpus tokens 214 before application of the n-gram generation rules 216 by which candidate n-grams failing to satisfy the rules for n-gram identification are removed or discarded from consideration as n-grams. In some embodiments, the n-gram generation rules further include a frequency criterion such as a predetermined threshold frequency or relative frequency of occurrence of any candidate n-gram within the set of corpus tokens, so as to exclude from the set of n-grams outliers or uncommon n-grams.

Thus, the pre-processor 226 generates the set of n-grams by identifying n-grams from groups of tokens in the set of corpus tokens 214. Subsequently, the pre-processor 226 is operable to pre-process the input text 208 to generate a set of input tokens 224 for processing by the NLP operation 230. A tokenizer 210b initially tokenizes the input text 208 using techniques substantially as previously described with respect to the tokenizer 210a. Notably, the tokenizers 210a and 210b may be constituted as the same hardware, firmware, software or combination component adapted to two applications: the tokenization of documents in the training corpus 206; and the tokenization of the input text 208. Alternatively, separate tokenizers can be employed. The tokenizer 210b thus generates an ordered set of input tokens 224. Subsequently, an n-gram detector component 222 is operable to process the set of input tokens 224 to identify groups of tokens in the set of input tokens 224 corresponding to n-grams in the set of n-grams 220. Thus, the n-gram detector 222 is operable on the basis of the set of n-grams generated 220 by the n-gram generator on the basis of the set of corpus tokens 214. Where the n-gram detector 222 identifies a group of tokens in the set of input tokens 224 corresponding to an n-gram in the set of n-grams 220, the identified group of tokens is replaced in the set of input tokens 224 by a singular n-gram token.

Subsequently, a stop word removal component 212b operates on the set of input tokens 214 processed by the n-gram generator 222 to remove stop words in the second set 202 from the set of input tokens 214. It is further noted that the second set 204 includes stop words being predetermined to be of potential semantic significance. Whereas the set of input tokens 224 is processed to remove the stop words of the second set 204, notably stop words of the second set 204 that are otherwise consolidated and replaced by n-gram tokens by the n-gram detector 222 (being n-grams generated based on the documents in the corpus 206 for which only stop words in the first set were removed) are still reflected in the set of input tokens 224. That is to say that stop words determined to be semantically significant and thus constituted in the second set 204 can be reflected in the set of input tokens 224 for processing by the NLP operation by virtue of their inclusion as part of an n-gram in the set of input tokens 224. In this way, embodiments of the present disclosure generate a set of input tokens 224 that include n-grams corresponding to semantically significant stop words that would otherwise be removed by conventional pre-processing operations.

In some embodiments, the operation of the pre-processor further includes other pre-processing operations including, for example, inter alia: each document in the training corpus 206 and the input text 208 are further pre-processed by normalization including one or more of: applying a consistent lower or uppercase to words; applying a stemmer function to words; and applying a lemmatization function to words.

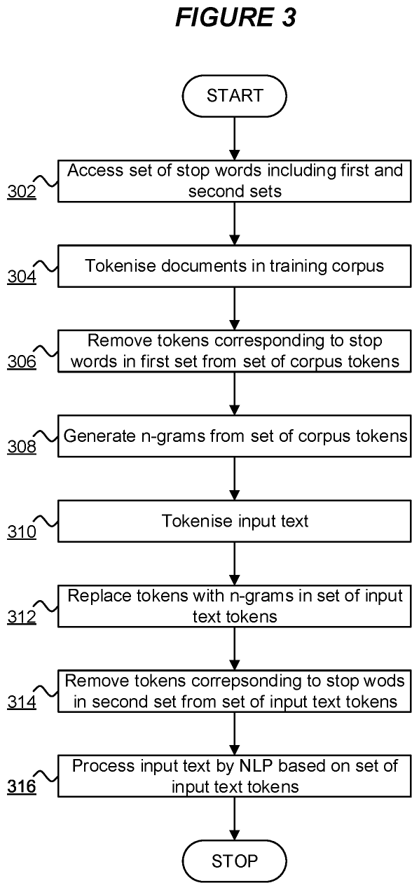

FIG. 3 is a flowchart of a method of pre-processing an input text 208 for an NLP operation 230 in accordance with embodiments of the present disclosure. Initially, at 302, the method accesses the set of stop words 200 including a first set 202 and a second set 204, the second set 204 containing stop words predetermined to be of potential semantic significance to documents in the training corpus 206. At 304 the method tokenizes documents in the training corpus to an ordered set of corpus tokens 214. At 306 the method removes tokens corresponding to stop words in the first set 202 from the set of corpus tokens 214. At 308 the n-gram generator 218 generates a set of n-grams 220 by identifying n-grams from groups of tokens in the set of corpus tokens 214 based on a set of n-gram generation rules 216. At 310 the method tokenizes the input text 208 to an ordered set of input text tokens 224. At 312 the method identifies groups of tokens in the set of input text tokens 224 corresponding to n-grams in the set of n-grams 220 and replaces, in the set of input text tokens 224, each identified group of tokens by a singular n-gram token. At 314 the method removes tokens corresponding to stop words in the second set 204 from the set of input text tokens 224. At 316 the method processes the input text 208 by the NLP operation 230 based on the set of input text tokens 224 generated and processed by 302 to 314.

Insofar as embodiments of the disclosure described are implementable, at least in part, using a software-controlled programmable processing device, such as a microprocessor, digital signal processor or other processing device, data processing apparatus or system, it will be appreciated that a computer program for configuring a programmable device, apparatus or system to implement the foregoing described methods is envisaged as an aspect of the present disclosure. The computer program may be embodied as source code or undergo compilation for implementation on a processing device, apparatus or system or may be embodied as object code, for example.

Suitably, the computer program is stored on a carrier medium in machine or device readable form, for example in solid-state memory, magnetic memory such as disk or tape, optically or magneto-optically readable memory such as compact disk or digital versatile disk etc., and the processing device utilizes the program or a part thereof to configure it for operation. The computer program may be supplied from a remote source embodied in a communications medium such as an electronic signal, radio frequency carrier wave or optical carrier wave. Such carrier media are also envisaged as aspects of the present disclosure.

It will be understood by those skilled in the art that, although the present disclosure has been described in relation to the above described example embodiments, the disclosure is not limited thereto and that there are many possible variations and modifications which fall within the scope of the disclosure.

The scope of the present disclosure includes any novel features or combination of features disclosed herein. The applicant hereby gives notice that new claims may be formulated to such features or combination of features during prosecution of this application or of any such further applications derived therefrom. In particular, with reference to the appended claims, features from dependent claims may be combined with those of the independent claims and features from respective independent claims may be combined in any appropriate manner and not merely in the specific combinations enumerated in the claims.

1. A computer implemented method of pre-processing an input text for a natural language processing operation based on a training corpus of documents, the method comprising:
accessing a set of stop words including predetermined words for de-emphasis in the input text for the natural language processing operation, the set of stop words being separated into at least two subsets including a first subset and a second subset, the second subset containing stop words predetermined to be of potential semantic significance to the documents in the training corpus;
tokenizing the documents in the training corpus to an ordered set of corpus tokens;
removing, from the ordered set of corpus tokens, tokens corresponding to stop words in the first subset of stop words;
generating a set of n-grams by identifying n-grams from groups of tokens in the set of corpus tokens based on predetermined rules for n-gram identification;
tokenizing the input text to an ordered set of input text tokens;
identifying groups of tokens in the set of input text tokens corresponding to n-grams in the set of n-grams and replacing, in the set of input text tokens, each identified group of tokens by a singular n-gram token;
removing, from the set of input text tokens, tokens corresponding to stop words in the second subset of stop words; and
processing the input text by the natural language processing operation based on the set of input text tokens for the input text.

2. The method of claim 1, wherein tokenizing includes identifying words and generating a token for each identified word.

3. The method of claim 1, wherein identifying n-grams from the groups of tokens in the set of corpus tokens further includes:
applying part of speech tags to each token in the set of corpus tokens;
generating a candidate n-gram for consecutive groups of n tokens in the set of corpus tokens; and
removing candidate n-grams failing to satisfy the rules for n-gram identification.

4. The method of claim 3, wherein the rules for n-gram identification include rules defining acceptable sequences of part of speech tags.

5. The method of claim 1, further comprising deduplicating the set of n-grams by consolidating n-grams containing identical sets of words irrespective of an order of the words.

6. The method of claim 1, wherein generating the set of n-grams further includes removing identified n-grams from the set of n-grams where a frequency of occurrence of each of the identified n-grams fails to meet a predetermined threshold frequency.

7. The method of claim 1, wherein each document in the training corpus and the input text are further pre-processed by normalization including one or more of: applying a consistent lowercase or uppercase to words; applying a stemmer function to words; or applying a lemmatization function to words.

8. A computer system comprising a processor and memory storing computer program code for performing the method of claim 1.

9. A non-transitory computer-readable storage medium storing a computer program element comprising computer program code to, when loaded into a computer system and executed thereon, cause the computer system to perform the method as claimed in claim 1.
